(19) United States
(12) Patent Application Publication
(10) Pub. No.: US 2015/0283510 A1
(43) Pub. Date: Oct. 8, 2015

(54) DEWATERING OF OIL SANDS TAILINGS USING IN SITU ELECTRO-OSMOSIS

(71) Applicant: SYNCRUDE CANADA LTD. in trust for the owners of the Syncrude Project as such owners exist now and, Fort McMurray (CA)

(72) Inventors: GEOFF HALFERDAHL, Edmonton (CA); ROBERT DONAHUE, Edmonton (CA)

(21) Appl. No.: 14/680,849

(22) Filed: Apr. 7, 2015

Related U.S. Application Data
(60) Provisional application No. 61/976,351, filed on Apr. 7, 2014.

(51) Int. Cl. B01D 57/02; C10G 1/00

(52) U.S. Cl. CPC B01D 57/02; C10G 1/00

(57) ABSTRACT

A process for dewatering oil sand fluid fine tailings comprising clay and water in a deposit, comprising: providing an anode and a cathode spatially separated from one another; applying a voltage gradient to produce a current between the anode and the cathode sufficient to move the water in the tailings towards the cathode; and removing the water which accumulates at the cathode.

### FIELD OF THE INVENTION

The present invention relates in general to a process for dewatering oil sands tailings having fine solids. More particularly, a voltage gradient is applied to oil sands tailings such as fluid fine tailings (FFT) to expel water from the tailings. The present invention is particularly useful in dewatering tailings in situ.

### BACKGROUND OF THE INVENTION

Excavated oil sand ore is generally comprised of water-wet sand grains with viscous bitumen in the void space between sand grains. Bitumen is a complex, variable and viscous mixture of large or heavy hydrocarbon molecules. The extraction of bitumen from oil sand ore using heated water and caustic produces tailings slurry. This tailings slurry is composed of solids, both fine and coarse, unrecovered bitumen and water. It is warm and has elevated pH due to heated water and caustic addition in the bitumen extraction process. As this tailings slurry is discharged into tailings impoundment structures (tailings facilities or tailings ponds), the coarse solids (sand), settle out quickly and form beaches (sub-aerial and sub-aqueous). The fine solids in this slurry, composed of silts and clays, are carried out into the center of the tailings pond where they accumulate and form a quasi-stable, gel-like suspension called fluid fine tailings (FFT).

Fine solids are commonly defined as particles less than 44 microns in diameter. The smaller sized fine solids e.g. less than. 5 microns, contribute most substantially to the FFT gel-like suspension that forms in ponds. When first discharged into ponds, the fine solids in FFT start out relatively dilute e.g. 5 to 15 wt. %, partly controlled by the pond water chemistry. After a few years through settlement and dewatering, they reach between about 30 and 35 wt. % after which the rate of further dewatering is extremely slow. FFT is generally defined a liquid suspension of oil sands fines in water with a solids content greater than 1% and having less than an undrained shear strength of 5 kPa.

Because the fine solids are bound up in the fluid fine tailings suspension, they exhibit fluid behavior and have very slow dewatering rates. Thus, they are challenging to include in a stable and reliable reclaimed landscape. Hence, the challenge facing the industry is the removal of much of the water from the fluid fine tailings suspension to enable the solids to no longer require fluid containment.

### SUMMARY OF THE INVENTION

Often when electricity is discussed with respect to water and solids, it is in relation to the treatment of water with about 0.5 to about 1% solids by weight or “dirty water”. However, such water treatment generally involves the movement or settling of the solids from the water mass.

In the present invention, however, the application of electrokinetics to a clay slurry, such as oil sand fluid fine tailings, primarily deals with a denser fluid, where water is expelled from the fluid mass to make it even more dense. Typically, fluid fine tailings residing in a tailings impoundment for more than about 3 years is about 35% solids by weight and is often referred to in the literature as mature fine tailings. More than 90% of these solids are less than 44 microns in size. When a voltage gradient is established in such a clay slurry between a positive and a negative electrode, positive ions in the pore water tend to move towards the negative electrode, referred to as the cathode. As these ions move, polar water molecules are dragged along with them towards the cathode, which is referred to herein as electro-osmosis or EO. Accumulated water at the cathode is removed, effectively making the slurry denser

EO dewatering is governed by the electro-osmotic conductivity (kₑ in m² sec⁻¹ Volt⁻¹) of the material, which is largely independent of particle size distribution. Intimate contact between electrode and conductive pore water in the material being treated is required for efficient use of electrical energy in EO dewatering.

Although electro-osmosis can be used in ex situ applications, the present invention is primarily focused on dewatering oil sands tailings having fine solids in situ, i.e., in a deposit rather than removing the tailings and applying electro-osmotic techniques in an ex situ manner such as a machine or a process vessel.

Thus, in one aspect of the invention, a process for dewatering oil sands tailings comprising clay and water present in a deposit is provided, comprising:
providing an anode and a cathode spatially separated from one another;
applying a voltage gradient between the anode and cathode to produce a current between the anode and the cathode sufficient to move the water towards the cathode; and
removing the water which accumulates at the cathode.
   In one embodiment, the voltage gradient is applied continuously. In another embodiment, the voltage gradient is applied intermittently or pulsed on and off.

In one embodiment, the oil sands tailings are fluid fine tailings (FFT) present in existing oil sand tailings impoundment and a series of electrodes are inserted into the FFT enabling in situ dewatering to occur. The electrodes are made with a high hydraulic conductivity element which facilitates efficient conductance of water produced from the material when subjected to EO dewatering.

In one embodiment, vertical drains such as pre-fabricated vertical drains can be installed in the oil sand tailings material to channel away pore water that comes out of the oil sand tailings material. Typical spacing of such vertical drains can be about 1 to about 3 meters. In one embodiment, electrodes can be embedded in the vertical drain and a voltage gradient is applied through the electrodes. These types of drains are sometimes referred to as electric vertical wick drains.

In one embodiment, special electrodes (anode and/or cathode) are used which are made from low electrical resistant materials and/or materials with low corrosion susceptibility. For example, such electrodes can be made of a metal wire mesh completely covered with an epoxy augmented with carbon black, to effectively conduct electricity but not be susceptible to corrosion.

In one embodiment, small surface ditches are provided at or near the cathode which have sufficient slopes to continuously conduct water produced at the cathode away (FIG. 2). In another embodiment, pumps are used at, near or even within the cathode drain to remove accumulating water produced from EO dewatering.

In one embodiment, the surface chemistry of the clay minerals present in the oil sands tailings such as FFT can be altered, resulting in a reduction of water associated with the clay minerals present in the tailings. For example, a fluid containing calcium or aluminum or any multivalent cation, can be added to FFT at the anode. When a voltage gradient is applied in the EO dewatering process, the cations permeate through the EO treated FFT and exchange onto the clay mineral surfaces reducing the volume of water contained within the clay mineral structure. Thus, in one embodiment, the process further comprises adding a chemically enriched fluid at or near the anode to geochemically alter the amount of water bound up with the clay minerals (reduce the double diffuse layer around the clay minerals) to increase the density of the FFT through which the chemically enriched fluid is moved under the forces generated by the application of a voltage gradient. It is understood that any multivalent cation e.g. calcium, aluminum, magnesium, etc. that can be transported by EO through the treated FFT and exchange with sodium ions on the clay mineral surfaces, thereby reducing the double diffuse layer on said clay minerals and thereby increasing the packing (arrangement) of clay minerals resulting in a denser material, can be used.

In another aspect of the present invention, gravity forces can be used in conjunction with electro-osmosis. For example, a free-draining material such as sand can be layered on top of FFT to provide a surface surcharge gravity load that can work at the same time as the EO, electrically driven, dewatering load. In one embodiment, a 3 to 5 meter layer of sand is used, applied in increments to avoid creating instability in the FFT caused by rapid loading. Thus, the surface surcharge load (i.e., gravity) can be an additional driving force that moves pore water out of FFT.

In one embodiment, solar photo-voltaic decentralized power is used to energize the electrodes.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a cross sectional schematic showing the basic principles of an electro-osmosis process of the present invention.

FIG. 2 is a perspective view of an embodiment of the present invention for dewatering oil sands fluid fine tailings using in-situ electro-osmosis.

FIG. 3A is a close-up perspective view of a section of FIG. 2.

FIG. 3B is a schematic illustrating the flow of water out of the cathode electric wick drains in one embodiment of the present invention.

FIG. 4 is a cross sectional schematic of the tub test described in the example.

FIG. 5 is a cross-sectional schematic of adding a fluid at the anode, another embodiment of the present invention.

FIG. 6 is a graph showing the amount of water collected at the cathode (ml) versus time (in hours) of one embodiment of the present invention.

FIG. 7 is a graph which shows the comparison of power consumption rate versus solids content for experiments using 5 V and 12 V, respectively.

### DETAILED DESCRIPTION OF THE PREFERRED EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

The present invention relates generally to a process for treating tailings derived from oil sands extraction operations and containing a fines fraction, and, particularly, dewatering the tailings to enable reclamation of tailings disposal areas and to recover water, which can be used for recycling or for release. As used herein, the term “tailings” means tailings derived from oil sands extraction operations and containing a fines fraction. The present invention is particularly useful for treating fluid fine tailings (FFT) derived from oil sands bitumen extraction operations and, particularly, dewatering these tailings to enable appropriate reclamation of tailings impoundments containing FFT. As used herein, “fluid fine tailings” or “FFT” is a liquid suspension of oil sand fines in water with a solids content greater than about 1 wt. %. “Mature fine tailings” or “MFT” are FFT with a low sand to fines ratio (SFR), i.e., less than about 0.3, and a solids content greater than about 15 wt. %. “Fines” are mineral solids with a particle size equal to or less than 44μ.

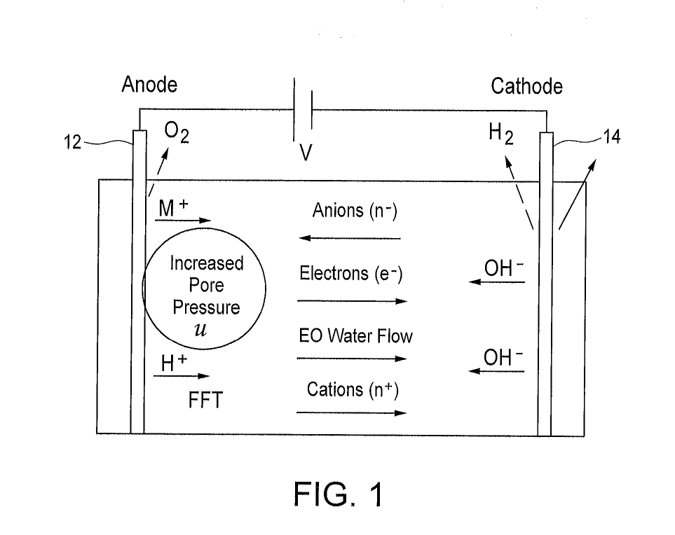

FIG. 1 is a cross sectional schematic of one embodiment of the process of the present invention using oil sands fluid fine tailings (FFT), more particularly, MFT. Two electrodes, anode 12 and cathode 14, are placed in the FFT a distance apart so that a continuous voltage gradient (V/m) can be applied to the anode 12 and cathode 14.

The applied voltage gradient set up increases pore water pressure in the vicinity of the anode, which then drives water towards to cathode, through the FFT. Anions (n⁻) will flow towards the anode 12 while cations (n⁺) and electrons (e−) will flow towards the cathode 14. The OH⁻ front migrates towards the anode 12 and the H⁺ front migrates towards the cathode 14 as EO treatment progresses. Metals (M+) will also migrate towards the cathode 14. Oxygen (O₂) will be released from the anode 12 region and hydrogen (H₂) will be released from the cathode 14 region.

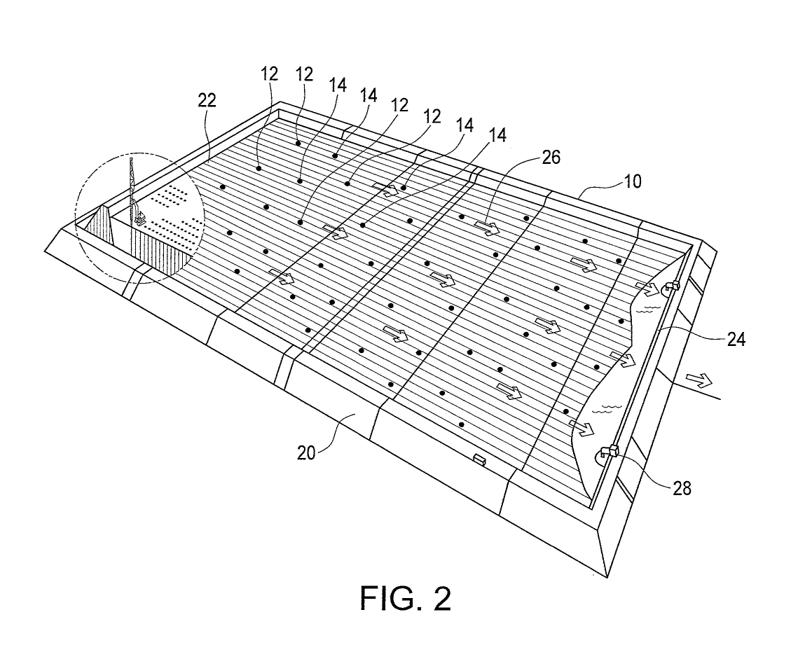

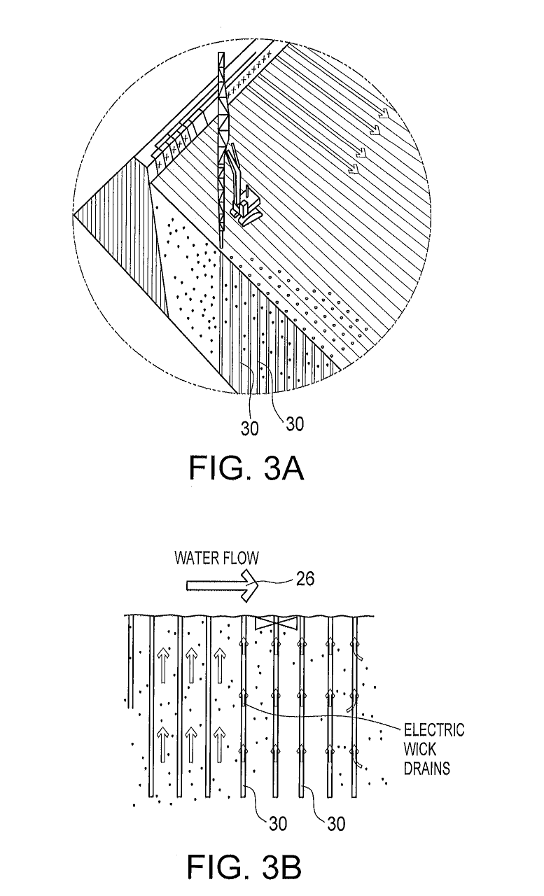

FIG. 2 is a schematic showing how EO can be used in situ in an existing tailings containment 10 having a containment dike 20. Pluralities of anodes 12 are positioned throughout the containment and pluralities of cathodes 14 are positioned spatially apart from the anodes 12. A continuous voltage gradient is applied to the electrodes 12, 14 to move water from within the FFT horizontal towards the cathodes. A pump 28 can be used to remove water accumulating at the second end 24 of the sloping FFT deposit. In one embodiment, as shown in FIGS. 3A and 3B, surface drainage ditches 26 connecting a series of vertical electric wick drains 30 collect the flow of water out of the cathode drains to aid in the drainage of water released from the FFT during EO

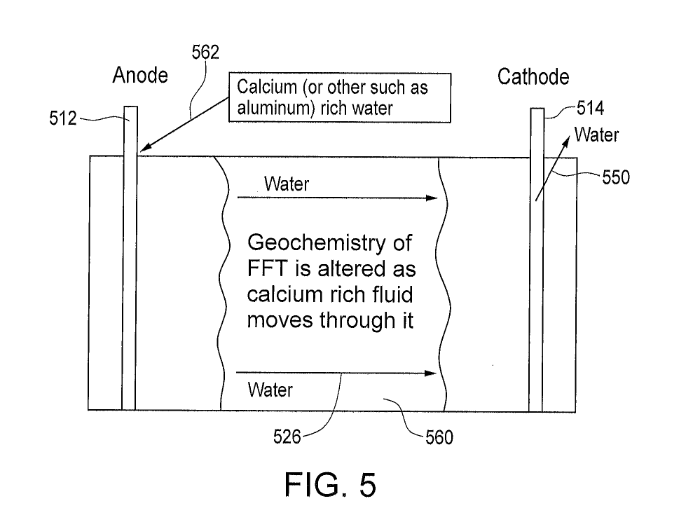

FIG. 5 is a cross-sectional schematic of another embodiment of the present invention. A fluid containing calcium or aluminum or any multivalent cation 562 can be added to FFT 560 at each anode wick drain 512. The geochemistry of the FFT is altered, as discussed previously, as this fluid 526 permeates through the FFT to towards the cathode 514. Water 550 is removed from the cathode end.

### EXAMPLE 1

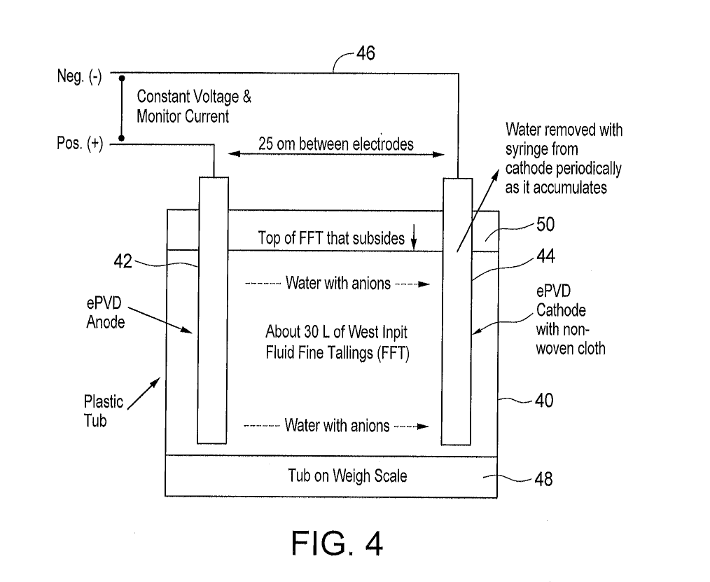

A tub test experiment was performed using FFT having about 34 wt % solids (also referred to as MFT). FIG. 4 shows a schematic cross-section of the tub test. Electrically conductive non-corrosive electrodes developed by Electrokinetic Limited, UK, were used in the tub test. The electrodes consisted of a metal wire mesh covered with a high-density polyethylene resin modified by adding carbon black to it. The metal wire mesh conducted electricity throughout the entire drain, thereby providing a more uniform current density across the electrode/ FFT pore water boundary. The cathode was covered by a non-woven geotextile cloth to prevent solids from migrating into the central annulus of the cathode from where accumulated water was removed with a syringe periodically.

With reference to FIG. 4, tub 40 was filled with about 36 L of fluid fine tailings (FFT). Anode 42 and cathode 44 were place at opposite ends of tub 40, spaced 25 cm apart. A power source (not shown) with constant 12 V DC 46 (0.5 V/cm) was connected to the electrodes 42, 44 and the current draw was monitored to track the electrical energy used. It is understood, however, that the optimal voltage for a given material to treat depends on the spatial separation of the anode and cathode, combined with the voltage gradient applied between them. A syringe connected to a length of tubing was used to remove water 50 periodically as it accumulated at the cathode 44. The pH and conductivity of each volume of water removed was measured. The tub 40 sat on a weigh scale 48 to enable tracking of the total tub weight and, therefore, the increasing density of the FFT during EQ. To minimize the loss of water through evaporation, a plastic covering was sealed over the top of the tub and around the electrode leads after each time water was removed at the cathode.

The solids content of the FFT went from 34 wt % to 43 wt % in about 650 hours under an applied voltage of 0.5 V per cm using 38 kW-hours (0.14 MJ) of electrical energy per dry tone of solids, The average current draw was about 0.05 amps under 12 V constant potential. The water released from the FFT at the cathode during EO treatment had a pH of about 12, and, therefore, might be useable at the front end of bitumen extraction from oil sand ore to reduce caustic addition.

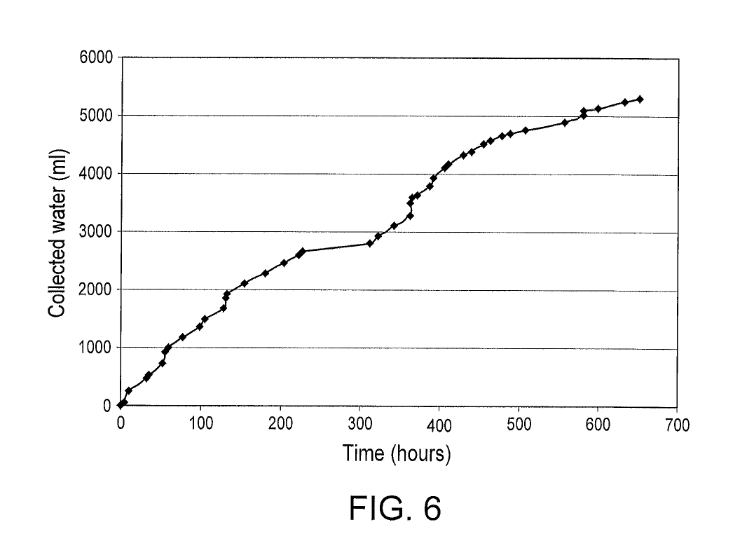

FIG. 6 is a graph showing the amount of water collected at the cathode (ml) versus time (in hours). It can be seen that the amount of water collected steadily increased during the duration of the test. Further, the consistency of the tailings at the end of the test was firm to stiff, particularly in the vicinity of the anode.

### EXAMPLE 2

A similar experiment was carried out as described in Example 1, with the only difference being that 5 V (0.2 V/cm) was used instead of 12 V (0.5 V/cm). Aside from this, all experimental procedures were the same as the 12 V test. The solids content of the FFT was slightly higher, i.e., 35 wt % versus 34 wt %, and the test ran for over 1300 hours. At the end of this period, water was still being collected in the cathode. Table 1 shows the measured solids content and undrained shear strength at the end of the 5 V test at various locations of the tub.

TABLE 1

| Location | Solids content (%) | Undrained shear strength (kPa) |
|---|---|---|
| Anode | 53.7 | 2.0 |
| Midway | 48.1 | 0.5 |
| Cathode | 47.1 | 0.2 |

The average solids content for the entire tub at the end of the test was approximately 44 wt %.

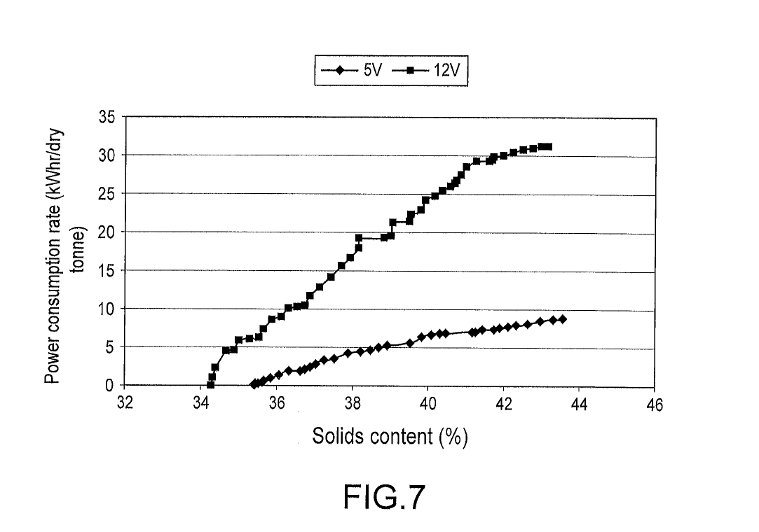

FIG. 7 is a graph which shows the comparison of power consumption rate versus solids content (based on measurements of mass using scales) for experiments using 5 V and 12 V, respectively. It can be seen in FIG. 7 that the change in solids content is similar for the two tests (slightly higher for the 12 V test, which started at a lower solids content). However, the power consumption rate for the 5 V test is about one quarter that for the 12 V test for comparable increases in solids. Thus, relatively low rates of power consumption are achievable.

The scope of the claims should not be limited by the preferred embodiments set forth in the examples, but should be given the broadest interpretation consistent with the description as a whole.

What is claimed:

1. A process for dewatering oil sands tailings comprising clay and water present in a deposit, comprising:
providing an anode and a cathode spatially separated from one another;
applying a voltage gradient between the anode and cathode to produce a current between the anode and the cathode sufficient to move the water in the tailings towards the cathode; and
removing the water which accumulates at the cathode.

2. The process as claimed in claim 1, wherein the voltage gradient is applied continuously.

3. The process as claimed in claim 1, wherein the voltage gradient is applied intermittently.

4. The process as claimed in claim 1, wherein the oil sand fluid fine tailings are present in an existing oil sand tailings impoundment and in situ dewatering occurs.

5. The process as claimed in claim 1, further comprising vertical drains to channel away pore water that comes out of the oil sands tailings material.

6. The process as claimed in claim 1, wherein the anode and/or cathode is made from good electrically conductive materials covered with a moderate electrically conductive and low corrosion susceptibility material.

7. The process as claimed in claim 6, wherein the anode and/or cathode is made from a carbon epoxy augmented with carbon black covering a metal wire mesh.

8. The process as claimed in claim 1, further comprising providing as least one small surface ditch at or near the cathode having a sufficient slope to continuously conduct water produced at the cathode away.

9. The process as claimed in claim 1, further comprising at least one pump at or near the cathode to pump out accumulating water.

10. The process as claimed in claim 1, further comprising adding a chemically enriched fluid at or near the anode to geochemically alter the amount of water bound up with the clay and increase the density of the tailings.

11. The process as claimed in claim 10, wherein the chemically enriched fluid contains a multivalent cation including calcium, aluminum, or magnesium.

12. The process as claimed in claim 1, further comprising applying a gravity force to the oil sands tailings.

13. The process as claimed in claim 12, whereby the gravity force comprises a free-draining material such as sand which is layered on top of the oil sand tailings to provide a surface surcharge load.

14. The process as claimed in claim 1, wherein the oil sands tailings are fluid fine tailings.

15. The process as claimed in claim 14, wherein the fluid fine tailings comprises about 15 to about 35 wt. % solids.
